(19) United States
(12) Patent Application Publication
(10) Pub. No.: US 2026/0073231 A1
(43) Pub. Date: Mar. 12, 2026

(54) SAFE META-REINFORCEMENT LEARNING (SAFE META-RL) PROMPTING FOR MACHINE LEARNING

(71) Applicant: International Business Machines Corporation, Armonk, NY (US)

(72) Inventors: Alexander Zadorojniy, HAIFA (IL); Ashlesha Akella, Bangalore (IN); Dharmashankar Subramanian, RYE BROOK, NY (US)

(21) Appl. No.: 18/882,709

(22) Filed: Sep. 11, 2024

(51) Int. Cl. G06N 3/092

(52) U.S. Cl. CPC G06N 3/092

(57) ABSTRACT

One or more parameters of a meta-reinforcement learning (meta-RL) model are updated, wherein the updated parameters comprise an update to an action space. A prompt is generated using the reinforcement learning model with the updated parameters for a large language model. The prompt is provided to the large language model to perform a downstream task.

### BACKGROUND

The present invention relates generally to the electrical, electronic and computer arts and, more particularly, to machine learning.

Large language models (LLMs) are often guided by prompts. While manual and semi-manual prompting can provide high accuracy, they require domain knowledge (such as an understanding of the corresponding dataset) and require manual labor that can be burdensome. Moreover, prompts, in general, do not take safety aspects into consideration; more specifically, prompt generation techniques, including prompts generated using reinforcement learning (RL) for LLMs, do not conventionally consider safety issues.

### BRIEF SUMMARY

Principles of the invention provide techniques for safe meta-RL prompting for machine learning. In one aspect, an exemplary computer-implemented method includes the operations of updating one or more parameters of a meta-reinforcement learning (meta-RL) model, wherein the updated parameters comprise an update to an action space; generating a prompt, using the reinforcement learning model with the updated parameters, for a large language model; and providing the prompt to the large language model to perform a downstream task.

In one aspect, a computer program product comprises one or more tangible computer-readable storage media and program instructions stored on at least one of the one or more tangible computer-readable storage media, the program instructions executable by a processor, the program instructions comprising updating one or more parameters of a meta-reinforcement learning (meta-RL) model, wherein the updated parameters comprise an update to an action space; generating a prompt, using the reinforcement learning model with the updated parameters, for a large language model; and providing the prompt to the large language model to perform a downstream task.

In one aspect, a system comprises a memory and at least one processor, coupled to the memory, and operative to perform operations comprising updating one or more parameters of a meta-reinforcement learning (meta-RL) model, wherein the updated parameters comprise an update to an action space; generating a prompt, using the reinforcement learning model with the updated parameters, for a large language model; and providing the prompt to the large language model to perform a downstream task.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates an example of an entity match task;

FIG. 2 is a block diagram of an example meta-reinforcement learning system, in accordance with example embodiments;

FIG. 3 provides an example definition of risk and corresponding constraints that need to be satisfied, in accordance with example embodiments; and

FIG. 4 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Given the discussion herein (reference characters refer to the drawings discussed below), it will be appreciated that, in general terms, an exemplary computer-implemented method, according to an aspect of the invention, includes the operations of updating one or more parameters of a meta-reinforcement learning (meta-RL) model, wherein the updated parameters comprise an update to an action space; generating a prompt 336, using the reinforcement learning model 328 with the updated parameters, for a large language model; and providing the prompt 336 to the large language model 344 to perform a downstream task. The technical benefits include improved automatic prompt generation for machine learning; improved reinforcement learning techniques for automatic prompt generation; and improved reinforcement learning techniques for automatic prompt generation with safety features.

In example embodiments, the updating of the one or more parameters includes reducing a size of the action space of the reinforcement learning model 328. The technical benefits include improved performance of the prompt generation by reducing the size of the action space that needs to be processed.

In example embodiments, the updating of the one or more parameters includes increasing a prompt length parameter of the reinforcement learning model 328. The technical benefits include improved performance of the prompt generation by selecting the best prompt length in terms of, for example, the number of tokens per prompt 336.

In example embodiments, the increasing of the length parameter is performed in conjunction with a reducing of a size of the action space for the reinforcement learning model 328. The technical benefits include improved performance of the prompt generation by reducing the size of the action space that needs to be processed while selecting the best prompt length in terms of, for example, the number of tokens per prompt 336.

In example embodiments, the use of the reinforcement learning model 328 is based on an immediate risk risk(s′, a) defined as:

$$risk ( {s}^{′} , a ) = ma x \{ {A}_{tg} - {A}_{c r} , 0.001 \} / ( T\_tr - t )$$

where t<T_tr−1, A_tg is an accuracy target, A_{cr} is a current batch iteration accuracy, T_tr is a single trial training time or training iterations, s_rem=T_tr−t is a new state variable, S′=S,s_rem is a new state space and wherein the immediate risk risk(s′, a) is defined over a batch of rows of a meta data table 308. The technical benefits include an improved definition of risk for the reinforcement learning process.

In example embodiments, the generating of the prompt 336 using the reinforcement learning model 328 further comprises inputting a task 304 and meta data 308 table, wherein the task 304 identifies the downstream task. The technical benefits include facilitating the performance of a downstream task using, for example, a task identifier and the generated prompt 336.

In example embodiments, the updating of the one or more parameters of the reinforcement learning model 328 is halted after a specified number of iterations, after a specified number of seconds or after a specified size reduction of the reduced dictionary. The technical benefits include improving the run time of the reinforcement learning process by providing a condition for halting performance of the machine learning process.

In example embodiments, the generated prompt 336 and an instance 340 are provided as input to the large language model 344. The technical benefits include facilitating the performance of a downstream task using the generated prompt 336 and the large language model 344.

In example embodiments, tokens of the generated prompt 336 are evaluated to identify tokens having a higher probability of success. The technical benefits include evaluating the tokens of the generated prompt 336 to improve the performance of the reinforcement learning process.

In example embodiments, a final output 356 of the large language model 344 is analyzed using a reward function 352 tailored for data wrangling tasks and a risk function 348 tailored for the data wrangling tasks and a result of applying the reward function is provided to the reinforcement learning model 328 as part of a reinforcement learning process. The technical benefits include improving the performance of the reinforcement learning process by analyzing the final output 356 of the large language model 344.

In example embodiments, a risk-aware objective function is defined as:

$$J ( θ ) = {E}^{{M}^{i}} [ \frac{τ ( π )}{\partial {( π )}^{ω}} \vert {f}_{θ} , {M}^{i} ] ,$$

where E^{M}^{ⁱ} is an expectation over Markov decision processes M (outer loop), θ is a meta-parameter, f_{θ} is a mapping to inner loop parameters, τ(π) is an inner loop expectation of reward over policy π, ∂(π)^{ω} is an expectation of risk over policy π (where the power is 0<ω≤1). The technical benefits include maximizing the expected reward per unit of expected risk when this objective function is maximized. This is opposite to a standard expected reward maximization where the risk is ignored and can be very high at maximum expected risk.

In one aspect, a computer program product comprises one or more tangible computer-readable storage media and program instructions stored on at least one of the one or more tangible computer-readable storage media, the program instructions executable by a processor, the program instructions comprising updating one or more parameters of a meta-reinforcement learning (meta-RL) model, wherein the updated parameters comprise an update to an action space; generating a prompt 336, using the reinforcement learning model 328 with the updated parameters, for a large language model; and providing the prompt 336 to the large language model 344 to perform a downstream task. The technical benefits include improved automatic prompt generation for machine learning; improved reinforcement learning techniques for automatic prompt generation; and improved reinforcement learning techniques for automatic prompt generation with safety features.

In one aspect, a system comprises a memory and at least one processor, coupled to the memory, and operative to perform operations comprising updating one or more parameters of a meta-reinforcement learning (meta-RL) model, wherein the updated parameters comprise an update to an action space; generating a prompt 336, using the reinforcement learning model 328 with the updated parameters, for a large language model; and providing the prompt 336 to the large language model 344 to perform a downstream task. The technical benefits include improved automatic prompt generation for machine learning; improved reinforcement learning techniques for automatic prompt generation; and improved reinforcement learning techniques for automatic prompt generation with safety features.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improved automatic prompt generation for machine learning;
improved reinforcement learning techniques for automatic prompt generation; and
improved reinforcement learning techniques for automatic prompt generation with safety features.

Generally, one or more embodiments provide techniques that automatically generate prompts for machine learning (ML) models, such as large language models (LLMs). The prompts provide context, descriptive information and/or other additional information to the ML model. Example embodiments improve the performance of LLMs for downstream tasks, such as data management, in a risk-aware manner. Advantageously, one or more exemplary embodiments do not need to understand the domain of the data to automatically generate the prompts. In example embodiments, the candidate dictionary is also automatically generated.

Practical applications for example embodiments include:
schema matching: finding semantic correspondences between elements of two schemas;
entity matching: identifying similar records across different structured sources;
error detection: detecting erroneous entries in a table;
data imputation: filling missing entries in a table; and
data transformation: converting data from one format to another.

### Prompts

Well-crafted prompts are pertinent for generating correct responses by the large language model in view of specific tasks. For example, the dramatic impact of the order of examples in the few-shot setting has been observed. As task complexity and the need for accurate responses increase, so does the need for well-crafted prompts, which allow large language models (LLMs) to learn in context.

Conventional efforts have crafted and tested prompt templates on five types of data tasks: (1) schema matching; (2) entity matching; (3) error detection; (4) data imputation; and (5) data transformation. The automated fine tuning of prompts is particularly pertinent for data management tasks, where the manual labor involved in prompt crafting is not an option—and neither is wrongly editing or eliminating critical data.

### Entity Matching

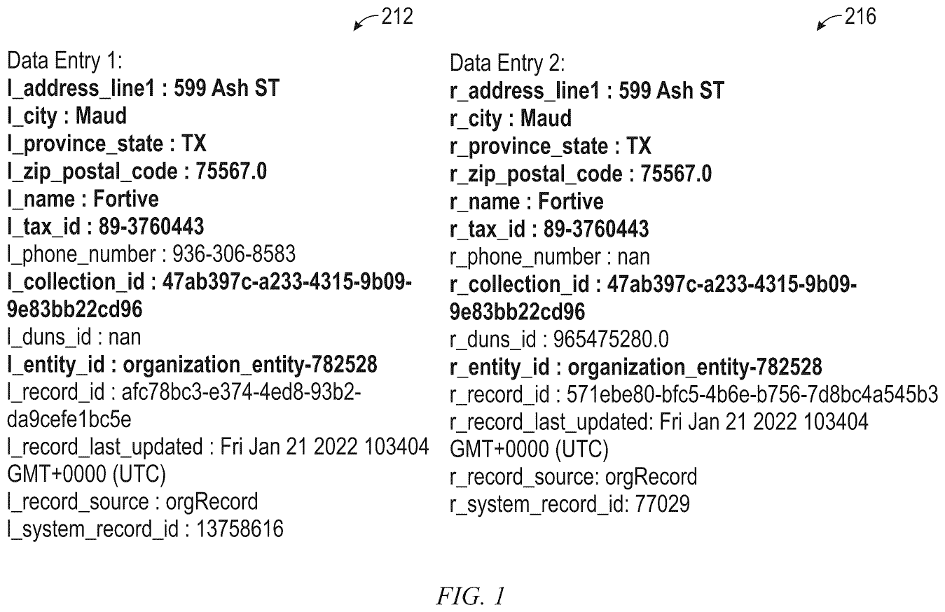

FIG. 1 illustrates an example of the entity match task. Entity matching is a task which involves identifying records across different datasets that refer to the same real-world entity, despite discrepancies like typographic errors or missing values. In the example of FIG. 1, two entries 212, 216 are compared to determine whether the two entries 212, 216 are similar. In the example of FIG. 1, the two entries 212, 216 are considered to be similar by a machine learning model.

### Automatic Prompt Generation

Consider the English vocabulary as an action space (A) where the state space(S) is “this is a table of electronic items with features, price, brand name:” augmented with actions. Initially, Sₜ_{ₒ}=“this is a table of electronic items with features, price, brand name:” At tᵢ₊₁, Sₜ_{ᵢ₊₁}=Sₜ_{ᵢ}+aₜ_{ᵢ} ∈A, i={0, . . . N} where aₜ_{ᵢ} is a token. For example, the state space may be revised to: “this is a table of electronic items with features, price, brand name: secret” by incorporating the token “secret.”

In example embodiments, the generated prompt is an embedding of the action into a textual description of a randomly sampled minibatch of data from a given data set. The output is text which should include the correct brand name. The reward is +3 if the brand is correct and −1 if the brand is not correct. The accuracy is the fraction of correct answers (a value between 0 and 1; a percentage between 0 and 100 could also be used).

### Prompt Example

A “Words/Dictionary” contains the most frequently used words from the provided dataset. Initially, the occurrence of each word in the dataset is calculated. The words are then sorted by their frequency, and the top words are selected for prompt construction using, for example, the following Words/Dictionary for prompt construction syntax: [‘Match by 1_record_id’, ‘1_entity_ids’].

In example embodiments, prompt tokens are generated automatically using machine learning. Words are typically encoded by tokens where only a few tokens are normally required to represent a whole word. Based on the accuracy of the results generated by a machine learning model, such as an LLM, the tokens with the highest reward are chosen to represent the word. It is noted that the decoding of tokens back to words or partial words is not required to generate proper English; the decoded tokens can simply be an arbitrary order of words or even portions of words.

For example, the following prompt tokens can be automatically generated:
[‘entity_ids 1_entity_ids’, ‘1_record_1_entity_ids’, ‘entity_ids Match by 1_record_’, ‘1_record_1_entity_ids’, . . .

In example embodiments, there are two different large language models used in the system: 1) a task large language model; and 2) a policy large language model. The task large language model, also referred to as task_11m, is employed for performing a downstream task, such as the entity matching task. In one example embodiment, a conventional generative large language model was used as the task large language model.

The policy large language model, also known as policy_11m, is utilized for the prompt generation. This smaller model is trained using reinforcement learning. In one example embodiment, a conventional generative large language model was used as the policy large language model.

### Action Space Size Issue

An action space (A) of the entire English vocabulary may be unrealistic to cover during training. Thus, automatic action space reduction is a pertinent task in prompting using LLMs. Moreover, for an example state space(S) of “this is a table of electronic items with features, price, brand name:” augmented with actions, the unsuccessful actions as well as the successful actions are conventionally augmented.

Considering an action space (A), let N be the number of potential words (where N<<the size of the English vocabulary), K be the average number of (different) tokens per word, and P be the number of tokens per prompt (assumption: P<<K*N), then the action size is O((KN)\hat{ }P). For example, if N=200, K=5 and P=5, there are 10\hat{ }15 possible different prompts which is prohibitively large.

Different initial word sets may be considered, such as the most frequently occurring words in a given text, domain specific words and the like. In example embodiments, a sufficiently large dictionary is selected and the size of the dictionary is iteratively reduced. For example, a dictionary of the N most frequently occurring words (where N is, for example, 5,000) can initially be chosen and the less successful tokens (such as the 50 least successful tokens) can be deleted from the dictionary at each iteration until a minimum number of tokens, such as 20, is reached. Alternatively, the iterative reduction may be halted, for example, after/iterations (where/=100, for example), after Sec seconds (where Sec=10, for example), after a size of the reduced dictionary is 1% of the size of the initial dictionary and the like. Similarly, the best prompt length in terms of, for example, the number of tokens per prompt can be determined.

### Meta-RL Action Filtering Method

In example embodiments, the action set is filtered to accelerate the convergence of the RL algorithm on a sufficiently good policy. The meta-RL algorithm automatically learns a successful parametrization for the reinforcement learning model. The meta-RL algorithm includes two loops: an outer loop and an inner loop. The outer loop with parameters (θ) has the goal to find successful parameters (φ where f_{θ}→φ) for the inner loop where the conventional reinforcement learning model is running. Trial i of an inner loop corresponds to a new Markov decision process MDPⁱ. The state space(S) and action space (A) are defined as:
Sⁱ=S—state space of MDPⁱ where state space is identical between all Markov decision processes (MDPs);
Aⁱ—action space of MDPⁱ where action spaces may vary between each MDP (this is distinguished from a standard Meta-RL approach where the action space is normally identical between all MDPs) and the action set is a set of words or phrases; where ∂(π) represents that risk is proportional to accuracy in this case.

It is noted that the conventional reinforcement learning model with a reduced action set will explore faster than with a larger action set, longer prompts, or both. For example, the most successful prompts of the previous meta-epoch (i.e., several epochs) are used for new tokens derivation and a parameter defining the number of tokens per prompt will increase over meta-iterations. In addition, the action set is kept small and might be updated, if needed with respect to (w.r.t.) an inner loop optimization and accuracy calculation. The top k actions (w.r.t. accuracy over the data of the current trial) are kept and, at most, |A|—k new actions are added (the top k can be identified using accuracy or most frequently used during testing); and the number of overall trials is N. In example embodiments, the Safe Meta-RL Risk-Aware Objective Function is defined as:

$$J ( θ ) = {E}^{{M}^{i}} [ \frac{τ ( π )}{\partial {( π )}^{ω}} \vert {f}_{θ} , {M}^{i} ] ,$$

where E^{M}^{ⁱ} is the expectation over Markov decision processes (MDPs) M (outer loop), θ is a meta-parameter, f_{θ} is a mapping to inner loop parameters, τ(π) is an inner loop expectation of reward over policy π, ∂(π)^{ω} is an expectation of risk over policy π (where the power is 0<ω≤1).

### Safe Meta-RL

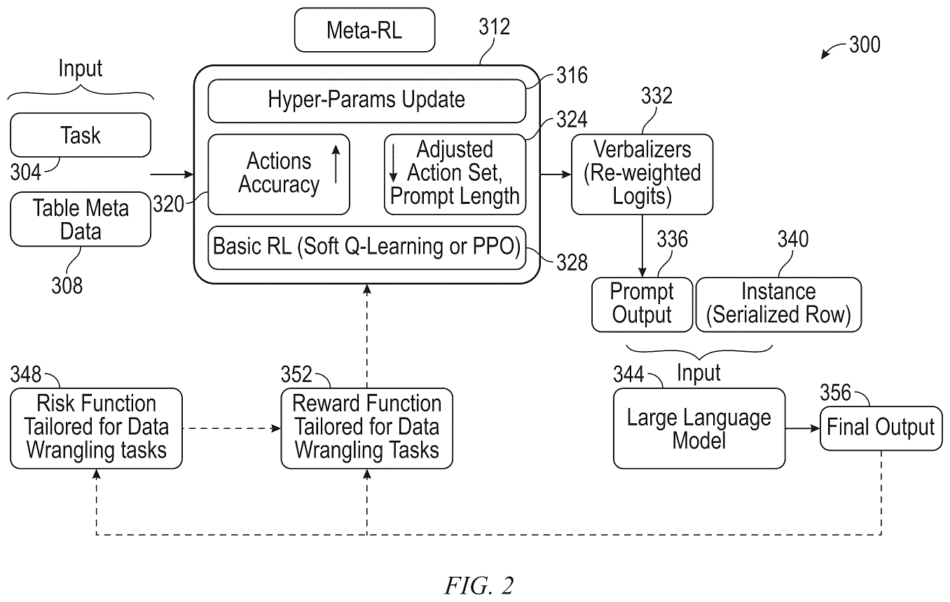

FIG. 2 is a block diagram of an example meta-reinforcement learning system 300, in accordance with example embodiments. The state of the system 300 includes the following inputs to the reinforcement learning system 300: a task 304 and table meta data 308. The task identifies the downstream task, such as a data imputation task, an entity matching task, an error detection and correction task, and the like. The generated prompts, as illustrated in FIG. 2, are embeddings of the table meta data 308 and associated actions. A meta-reinforcement learning module 312 includes a hyper-parameter update module 316 and a conventional reinforcement learning model 328 that is based on, for example, soft Q-learning or proximal policy optimization (PPO). (Soft Q-learning is an algorithm in reinforcement learning that enhances the learning of text generation with limited data. Proximal policy optimization is a policy gradient algorithm for reinforcement learning to train the policy large language model.) The reinforcement learning model 328 performs an inner loop, where prompts are generated and the hyper-parameter update module 316 performs an outer loop, where parameters 324 for the reinforcement learning model 328 are generated. For example, the hyper-parameter update module 316 may reduce a size of an action space for the reinforcement learning model 328, increase a length parameter of the prompts to be generated, or both. For example, the length of the prompt can be increased, e.g., by 5 to 10 tokens for each iteration of the outer loop in a search for the shortest length that has a satisfactory accuracy of the system 300. As the prompt length increases, the action size may become prohibitively high. Thus, in example embodiments, the prompt length is increased as the action space is reduced. (It is noted that the updating of other parameters by the hyper-parameter update module 316 is also contemplated. Moreover, a target accuracy may be specified and used to determine if the accuracy is satisfied.) Thus, as illustrated in FIG. 2 at 320, the actions (a sequence of tokens tailored to datasets and tasks) and accuracy attained by the reinforcement learning model 328 are provided to the hyper-parameter update module 316 and an updated action set, prompt length, or both (see 324) are provided to the reinforcement learning model 328. The updating is halted after/iterations (where/=100, for example), after Sec seconds (where Sec=10, for example), after a size of the reduced dictionary is, for example, 1% of the size of the initial dictionary and the like.

The prompts generated by the reinforcement learning model 328 are provided as a prompt output 336. The prompt output 336 is provided as input, together with an instance 340 (such as one or more serialized rows of the table meta data 308) to a large language model 344. For example, the input to the large language model 344 may be a task, such as task 304, and serialized table text, such as table meta data 308, with prompts, such as prompt output 336. In one example embodiment, the input to the large language model 344 includes rows of the table meta data 308 concatenated with the prompt output 336.

The large language model 344 generates a final output 356 based on the input to the LLM 344. In one example embodiment, the tokens of the prompt output 336 are evaluated to determine the tokens having a higher probability of success; for example, having a higher probability of the final output 356 generating a positive reward.

The token evaluator task may be implemented as a conventional token evaluator and may be implemented as part of the meta-reinforcement learning module 312 or external to the meta-reinforcement learning module 312, such as by conventional token evaluator 332.

The final output 356 is analyzed by a reward function 352 tailored for data wrangling tasks and a risk function 348 tailored for data wrangling tasks, as described more fully below. The result of the reward function is provided to the reinforcement learning model 328 as part of the reinforcement learning process.

Inner Loop Objective Function with Risk

In example embodiments, the immediate risk is defined over a batch of several rows of the table meta data 308. In one example embodiment, the immediate risk (risk(s, a)) is defined as:

$$risk ( {s}^{′} , a ) = max \{ {A}_{tg} - {A}_{c r} , 0.001 \} / ( {T}_{tr} - t )$$

where t<Tₜᵣ−1, A_{tg} is an accuracy target (e.g., 0.8), A_{cr} is a current batch iteration accuracy, Tₜᵣ is a single trial training time or training iterations (e.g., 1000 iterations), s_rem=Tₜᵣ−t is a new state variable (number of remaining training iterations), and S′=S ∪s_rem is a new state space. Thus, the risk will be smaller when a high accuracy is reached in a small number of iterations and the risk will be high when the accuracy is still low after a large number of iterations. To avoid negative risk (in the case where A_{tg}<A_{cr}), a small number (e.g., 0.001) will be set in this case, as defined below. Big_{number} is a scaling parameter (which can be ignored for simplicity).

$$risk ( {s}^{′} , a ) = {Big}_{n u m b e r} * max \{ {A}_{t g} - {A}_{cr ( t = {T}_{t r} - 1 )} , 0.001 / {Big}_{n u m b e r} \} , t >= {T}_{tr} - 1$$

In one example embodiment, the immediate reward (r(s′,a)) is based on: r(s′, a)=+K,−N (success, failure for a single row).

The expectation of risk over policy π is defined as:

$$Risk ( π ) = {E}^{π} ( risk ( {s}^{′} , a ) )$$

The expectation of reward over policy π is defined as:

$$Reward ( π ) = {E}^{π} ( r ( {s}^{′} , a ) ) \qquad ( assumed to be positive )$$

In one example embodiment, the horizon is infinite. The objective function is defined as:

$$J ( θ ) = {E}^{{M}^{i}} [ [ Reward ( π ) / {Risk ( π )}^{w} \vert {f}_{θ} , {M}^{i} ] ]$$

### Safe MDP Mathematical Programming Formulation

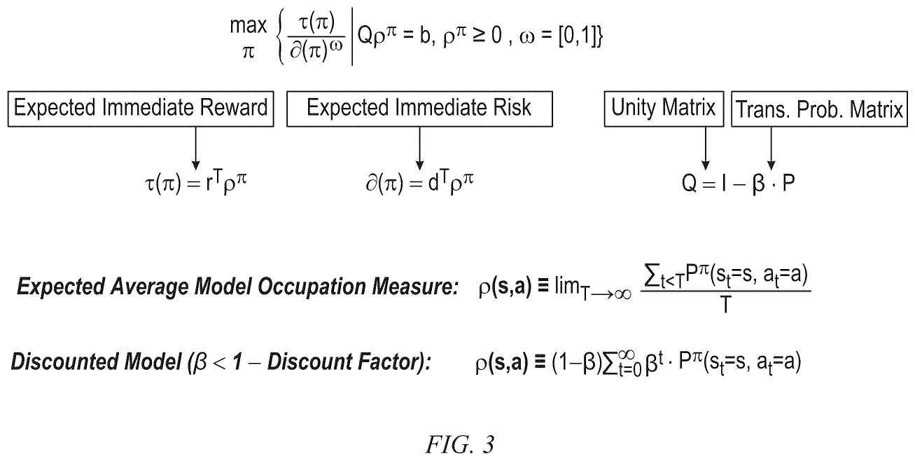

FIG. 3 provides an example definition of risk and corresponding constraints that need to be satisfied, in accordance with example embodiments. As defined in FIG. 3, the ratio of the expected reward to the expected risk is to be maximized.

### Non-limiting Exemplary Application

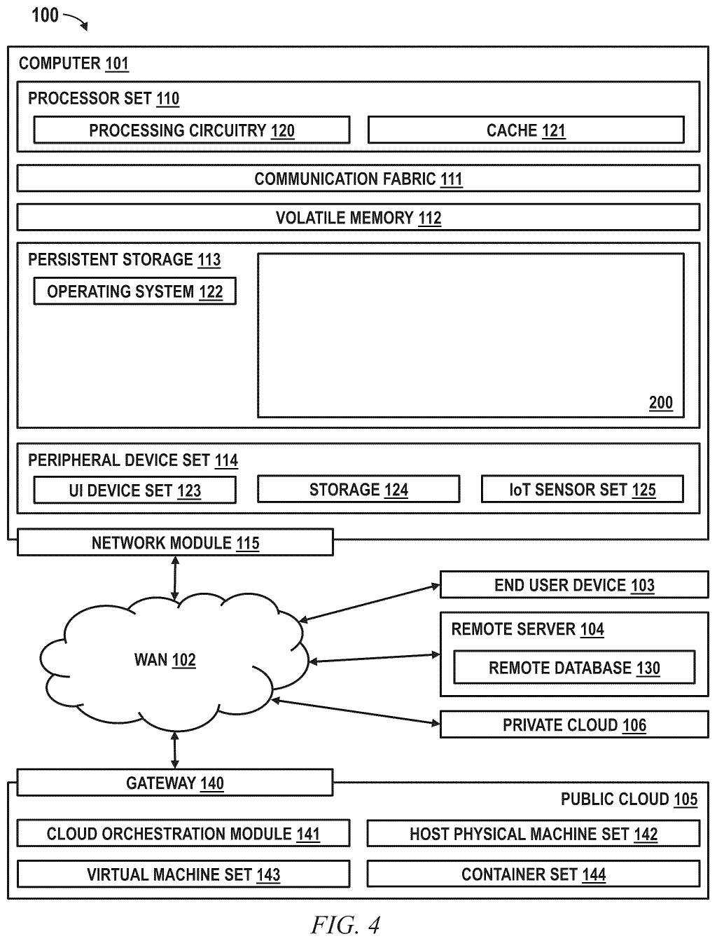

In a non-limiting exemplary application, operations of a wastewater treatment plant (WWTP) are controlled using the large language model (LLM) 344 and prompts generated via the meta-reinforcement learning (RL) module 312. The action space includes various set points of the wastewater treatment plant with their specified range of possible values. Thus, in this aspect, the downstream task involves control of a WWTP; the actions space includes various set points with their range of possible values; and RL will provide a prompt for the LLM for more efficient plant control. For example, referring to FIG. 4, which is discussed further below, one or more software modules 200 implement aspects of the invention. These one or more software modules in turn control hardware (e.g., valves with hydraulic, pneumatic, or electrical activators) represented by end user device 103 over WAN 102, or by other wired and/or wireless connectivity such as cabling or the like.

### Experimental Results

Experiments were conducted using the system 300 of FIG. 2. The target was to impute a brand for an electronic domain problem. A conventional LLM (GPT2) was used as the LLM. The reinforcement learning (RL) was based on PPO on top of the LLM. A constrained action set and greedy risk approach were used. The accuracy measured was around 80% for some random mini-batches (a number of rows from the data set that were randomly sampled with a number of rows equal to some predefined number).

It is noted that, in example embodiments, the updating of the one or more parameters of the reinforcement learning model is based on one or more actions and an accuracy attained by the reinforcement learning model, wherein each action is a sequence of tokens.

Refer now to FIG. 4.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as prompt generator or machine learning system including a prompt generator 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 4. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
updating one or more parameters of a meta-reinforcement learning (meta-RL) model, wherein the updated parameters comprise an update to an action space;
generating a prompt, using the reinforcement learning model with the updated parameters, for a large language model; and
providing the prompt to the large language model to perform a downstream task.

2. The computer-implemented method of claim 1, wherein the updating of the one or more parameters includes reducing a size of the action space of the reinforcement learning model.

3. The computer-implemented method of claim 1, wherein the updating of the one or more parameters includes increasing a prompt length parameter of the reinforcement learning model.

4. The computer-implemented method of claim 3, wherein the increasing of the length parameter is performed in conjunction with a reducing of a size of the action space for the reinforcement learning model.

5. The computer-implemented method of claim 1, wherein the use of the reinforcement learning model is based on an immediate risk risk(s′, a) defined as:
$$risk ( {s}^{′} , a ) = max \{ {A}_{tg} - {A}_{c r} , 0.001 \} / ( {T}_{tr} - t )$$
where t<Tₜᵣ−1, A_{tg} is an accuracy target, A_{cr} is a current batch iteration accuracy, Tₜᵣ is a single trial training time or training iterations, sᵣₑₘ=Tₜᵣ−t is a new state variable, S′=S∪sᵣₑₘ is a new state space and wherein the immediate risk risk(s′, a) is defined over a batch of rows of a meta data table.

6. The computer-implemented method of claim 1, wherein the generating of the prompt using the reinforcement learning model comprises inputting a task and meta data table, wherein the task identifies the downstream task.

7. The computer-implemented method of claim 1, wherein the updating of the one or more parameters of the reinforcement learning model is halted after a specified number of iterations, after a specified number of seconds or after a specified size reduction of the reduced dictionary.

8. The computer-implemented method of claim 1, further comprising providing the generated prompt and an instance as input to the large language model.

9. The computer-implemented method of claim 1, further comprising evaluating tokens of the generated prompt to identify tokens having a higher probability of success.

10. The computer-implemented method of claim 1, further comprising:
analyzing a final output of the large language model using a reward function tailored for data wrangling tasks and a risk function tailored for the data wrangling tasks; and
providing, to the reinforcement learning model, a result of applying the reward function as part of a reinforcement learning process.

11. The computer-implemented method of claim 10, wherein a risk-aware objective function is defined as:
$$J ( θ ) = {E}^{{M}^{i}} [ \frac{τ ( π )}{\partial {( π )}^{ω}} \vert {f}_{θ} , {M}^{i} ] ,$$
where E^{M}^{ⁱ} is an expectation over Markov decision processes M, θ is a meta-parameter, f_{θ} is a mapping to inner loop parameters, τ(π) is an inner loop expectation of reward over policy π, ∂(π)^{ω} is an expectation of risk over policy π.

12. A computer program product, comprising:
one or more tangible computer-readable storage media and program instructions stored on at least one of the one or more tangible computer-readable storage media, the program instructions executable by a processor, the program instructions comprising:
updating one or more parameters of a meta-reinforcement learning (meta-RL) model, wherein the updated parameters comprise an update to an action space;
generating a prompt, using the reinforcement learning model with the updated parameters, for a large language model; and
providing the prompt to the large language model to perform a downstream task.

13. The computer program product of claim 12, wherein the updating of the one or more parameters includes reducing a size of the action space of the reinforcement learning model.

14. A system comprising:
a memory; and
at least one processor, coupled to said memory, and operative to perform operations comprising:
updating one or more parameters of a meta-reinforcement learning (meta-RL) model, wherein the updated parameters comprise an update to an action space;
generating a prompt, using the reinforcement learning model with the updated parameters, for a large language model; and
providing the prompt to the large language model to perform a downstream task.

15. The system of claim 14, wherein the updating of the one or more parameters includes reducing a size of the action space of the reinforcement learning model.

16. The system of claim 14, wherein the updating of the one or more parameters includes increasing a prompt length parameter of the reinforcement learning model.

17. The system of claim 16, wherein the increasing of the length parameter is performed in conjunction with a reducing of a size of the action space for the reinforcement learning model.

18. The system of claim 14, the operations further comprising providing the generated prompt and an instance as input to the large language model.

19. The system of claim 14, the operations further comprising evaluating tokens of the generated prompt to identify tokens having a higher probability of success.

20. The system of claim 14, the operations further comprising:
analyzing a final output of the large language model using a reward function tailored for data wrangling tasks and a risk function tailored for the data wrangling tasks; and
providing, to the reinforcement learning model, a result of applying the reward function as part of a reinforcement learning process.
